(19) United States
(12) Patent Application Publication
(10) Pub. No.: US 2020/0382562 A1
(43) Pub. Date: Dec. 3, 2020

(54) CHANGING ORIGINATION AND TERMINATION CALLING MODES

(71) Applicant: T-Mobile USA, Inc., Bellevue, WA (US)

(72) Inventor: Vinod Ravichandran, Renton, WA (US)

(21) Appl. No.: 16/425,499

(22) Filed: May 29, 2019

(51) Int. Cl. H04L 29/06

(52) U.S. Cl. CPC H04L 65/1069; H04W 88/06; H04L 65/1016; H04L 65/1006

(57) ABSTRACT

Systems and methods for using the native dialer of a user equipment or the application dial of an application to originate or terminate calls on behalf of an application installed on the user equipment are discussed herein. The user equipment informs the cellular network of a calling mode in which the application will operate. When originating a phone call using the native dial of the user equipment, the user equipment sends one or more messages that may include a user equipment identifier, an application identifier, and a destination identifier to the cellular network. In one example, the cellular network replaces the user equipment identifier with the application identifier and transfers the call to the destination. To receive a call by the native dialer on behalf of an application, the destination sends a call request to the cellular network. The cellular network transfers the call to the native dialer, which terminates the call and forwards the call to the application.

### BACKGROUND

User equipment such as mobile devices often include a native dialer for originating or terminating phone calls. Besides making and receiving phone calls, a native dialer may provide additional services such as call forwarding, call merging, and basic conference calling. To enhance the user's calling experience, third party over-the-top (OTT) applications may be installed on user equipment. These OTT applications may include an application dialer for making and receiving phone calls over a data network such as the Internet. The OTT application with the application dialer may include functionality enhanced beyond that provided by the native dialer. For example, the OTT application may provide enhanced conference calling, call merging, and video calls. The functionality provided by the native dialer and an application dialer are separately accessible. For example, the user must choose between using the functionality of the native dialer or the application dialer of the OTT application. A user cannot access the functionality of the native dialer on the user equipment when using the OTT application. Similarly, the user cannot access the functionality of the application dialer installed with the application when using the native dialer of the user equipment.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1A illustrates an example environment for changing the origination and termination calling modes of a user equipment.

FIG. 1B illustrates an example process for communication between a user equipment, an application, a web services gateway, and an application server.

FIG. 2 illustrates an example user equipment for changing the origination and termination calling modes of the user equipment.

FIG. 3 illustrates an example computer system of a cellular provider for changing the origination and termination calling modes of a user equipment.

FIG. 4 illustrates an example process by a user equipment for registering a calling mode of a user equipment.

FIG. 5 illustrates an example process by a user equipment for registering a calling mode of a user equipment.

FIG. 6 illustrates an example process by an application server for registering a calling mode of a user equipment.

### DETAILED DESCRIPTION

Described herein systems and methods for selecting a dialer for originating and terminating calls. In an example, a user may select a calling mode that may determine the selection of a dialer. A user may select a calling mode within an application. Alternatively, a user may select a calling mode to be used with any application. The selection of a calling mode permits selection of either the native dialer of the user equipment or an application dialer installed with an application. The disclosed systems and methods leverage the functionality of an application's dialer, while using the native dialer to perform the origination or termination of the call. Because the application dialer uses the user equipment's data connection to the Internet, calls made using the application dialer compete with other data applications of the user equipment and the quality of the data network. On the other hand, calls made using the native dialer use a dedicated bearer or pipe providing a minimum quality of service for calls made by the native dialer of the user equipment. Calls made by the native dialer of the user equipment do not compete with other data requests, whether from the user equipment or from other devices using the data network.

For clarity, the systems and methods provided herein are described in terms of session initiation protocol (SIP) messages. One of skill in the art will recognize, however, that the systems and methods described herein are equally applicable to other protocols such as, for example, hypertext transfer protocol (HTTP), message session relay protocol (MSRP), or other current or future messaging protocols. The system is also described below for use with current technology networks (e.g., 4G LTE networks, 5G networks, etc.). One of skill in the art will recognize, however, that similar solutions could be used for establishing one-way video calls on 5G, Internet of Things (IoT), machine-to-machine (M2M), and even future network technologies that have yet to be invented. Thus, the use of 2G, 3G, 4G LTE, and 5G in the examples below is simply a reflection of current technologies and is not meant to limit the application. Indeed, one of ordinary skill in the art will see that the system could also be used, with little or no modification, with online video conferencing and other technologies.

Using the native dialer of the user equipment for making calls on behalf of an application decouples the quality of calls made by the application from the quality of the data channel used by the application to make the call. In some examples, the quality of a call made by an application using the native dialer is not dependent on the quality of the data channel coupled to the application. The systems and methods disclosed herein employ the benefits of the native dialer of the user equipment combined with the benefits of the dialer of the application to use the features of the application along with the dedicated bearer of the native dialer to produce an enhanced user experience.

Over-the-top (OTT) applications may be installed on user equipment to provide telecommunication functions such as making or receiving a call, merging calls, putting a call on hold, conference calling, and video conferencing, among other functions. These OTT applications may provide a dialer for originating or terminating phone calls and may have access to a user account that is associated with a single telephone number or multiple telephone numbers that are associated with the user account. In an example, OTT applications may use the Internet connection of the user equipment to offer telecommunication services to make and receive calls. The cellular network of the cellular provider may provide the user equipment with a data connection to the Internet. In an example, an access point such as a Wi-Fi access point may provide the user equipment with a direct connection to a network such as the Internet and/or a web service gateway. In one example, an OTT voice application may use the user equipment's data connection to the Internet over an LTE network to offer a voice service that is independent of the cellular service provider. In an example, the OTT application does not access a cellular voice channel dedicated to the native dialer. In some examples, a user may utilize the OTT application to login to a user account thereby providing the user access to telephone number(s) that are associated with the user account.

In one example, the cellular network is a terrestrial radio network distributed over land through cells. Each such cell may include a fixed location transceiver known as a base station. The cells in the aggregate may provide radio coverage over a larger geographical region. In an example, the last link in a cellular or mobile network is a wireless link to provide user equipment with access to a network such as the Internet.

The application may operate in a cellular mode or a data mode when performing voice services. For example, the application may access a data channel of the cellular provider when connected to the Internet via the cellular channel. The application may also access an unlicensed data channel such as a Wi-Fi channel when providing voice services. In either case, the voice services of the application compete with other data services such as web browsing and audio or video streaming. The quality of a call made or received by the application may be dependent on the quality of the data channel. Moreover, data connections may not provide a guaranteed quality of service for voice packets transported through the data network. As the quality of the data network degrades (e.g., quality of Wi-Fi connection or cellular connection degrades), the quality of the voice services provided by the application diminishes.

The native dialer of the user equipment uses a dedicated bearer—call channel or pipe—that is accessed only by the native dialer. The dedicated bearer for the native dialer provides a minimum quality of service to enhance the user experience. In an example, the user may choose to use the native dialer with the OTT application, enabling the data to be transported through the dedicated pipe for the native dialer, reducing the impact of quality of the data network on the quality of the phone call made on behalf of the OTT application. One way to choose the native dialer is to select a cellular mode. Moreover, the quality and throughput of data packets communicated with a user equipment in a poor cellular coverage area may be reduced, thereby reducing the quality of calls made by OTT applications. In one example, because calls made or received using the native dialer with the dedicated bearer call channel meet a minimum quality of service, in a poor cellular coverage area, calls made using the native dialer typically have improved call quality as compared to the call quality using the application dialer in the poor cellular coverage area.

The user equipment in one example may be any device that includes a cellular radio for communications with a cellular network. For example, a user equipment may be a mobile phone, a smart phone, a computer, a tablet computer, a wearable device, and the like. The user equipment may connect with the cellular network via a microcell. In an example, the user equipment may connect with the cellular network via small cell, a microcell, a picocell, or a femtocell. The cellular radio of the user equipment may provide a voice connection and a data connection between the user equipment and the cellular network. In an example, the voice channel includes a channel for dedicated use by the native dialer of the user equipment. The user equipment may also have a non-licensed wireless data channels such as a Wi-Fi, Bluetooth, WiMax, or infrared ports. In an example, the user equipment may also have an additional licensed wireless connection.

A user equipment such as a mobile phone may include a native dialer installed with the operating system and an OTT application installed with an application dialer. In one example, a user selects a calling mode for use with the OTT application. The user may select to use the native dialer installed with the operating system or the application dialer installed with the application for making or receiving calls using the application. This selection may occur via choosing a cellular mode or a data mode. When the user selects the application dialer to perform the telecommunications functions, the call is made using user equipment's data connection to the Internet (either over the LTE network, or a direct connection to the Internet) to provide voice services that are independent of the cellular network provider. When the user selects the native dialer of the operating system to perform the telecommunication functions such as a video call, the video call is made using a dedicated bearer for the voice component and a dedicated bearer for the video component of the call.

The dialer for the OTT application may be selected in various ways. For example, the dialer may be selected during installation of the OTT application on the user equipment. The dialer may be selected after installation of the application on the user equipment. The dialer may be selected whenever a call is originated or terminated by the application. In an example, the application includes the executable instructions and logic for the dialer election. In an example, the operating system of the user equipment may include the executable instructions and logic for the dialer selection.

In an example, the dialer may be selected based on a calling mode selection. A user may choose to operate the user equipment in a cellular mode. When in cellular mode, a user equipment may use the native dialer to make or terminate calls. When in data mode, a user equipment may use an application dialer to make or terminate calls. A user may select a cellular mode or data mode based on a user setting on the phone. A user may select a cellular mode or a data mode using a feature of an application.

When the user selects the native dialer (i.e., cellular mode) to perform telecommunication functions of the application, the user equipment and/or the application may inform the cellular network that the native dialer is the preferred dialer for originating and/or terminating calls for the user equipment. The user equipment may notify the cellular network in various ways. In an example, the user equipment notifies the IMS Subsystem as to the preferred dialer for the user equipment. By notifying the IMS Subsystem, calls made by, or made to, the native dialer on behalf of the application are identified and processed accordingly. A message may be sent to the IMS Subsystem to inform the IMS subsystem that a native dialer will be used on behalf of an application. The user equipment may also inform the cellular network of the preferred dialer based on a selection of cellular calling model or data calling mode.

The message may include an identifier of native dialer and an identifier of the application. One example of an identifier of the native dialer is a telephone number of the user equipment. The identifier of the native dialer of the user equipment may be obtained from the SIM card of the user equipment. In another example, telephone number and/or other SIM information of the user equipment may be obtained from a Universal Subscriber Identity Module (USIM) of a user equipment rather than from a SIM. In an example, the identity of the preferred dialer may be obtained by querying a cellular database for the Subscriber Information Module (SIM) number of the user equipment. An example cellular database is a Home Subscriber Server database. In an example, the SIM information, including the telephone number of the user equipment, may be transmitted from the user equipment to the cellular network for storage in the carrier backend system. The SIM information may be stored in a database accessible by the carrier backend. The identifier of an application may be a number or label associated with the application that allows identification of the application. The message may also include the telephone number(s) associated with the user account that the application is logged into and an instruction to create an affiliation between the telephone number of the native dialer and the telephone number(s) associated with the user account that the application is logged into.

After receiving a message that a native dialer will be used for an OTT application, calls made to, or by an, application may be redirected as calls made to, or by the native dialer. In one example, the carrier backend redirects calls made from the native dialer on behalf of the application to appear to the destination as originating from the application. In an example, the IMS Subsystem of the cellular network performs the redirection.

One example method of placing a call by the native dialer on behalf of an application includes authenticating the SIM information, including the phone number, of the user equipment. The authentication of the SIM information may be performed by the IMS Subsystem, by the Evolved Packet Core (EPC), or other parts of the carrier backend systems. When the application prepares to make or originate a call, the application informs the IMS Subsystem of the cellular network that a call originating from the application to a destination device will be made by the native dialer. In one example, the application sends an application identifier identifying the calling application (e.g., telephone numbers associated with a user account that the application is logged into), a user equipment identifier identifying the user equipment that includes the installed application making the call (e.g., a telephone number associated with the user equipment), and a destination identifier identifying the destination or termination of the call. Upon sending the application identifier, the user equipment identifier, and the destination identifier to the IMS Subsystem of the cellular network, the native dialer of the user equipment originates the call to a temporary number. In one example, the temporary number is associated with the IMS Subsystem of the cellular network. This call may be made using the dedicated cellular channel accessible only by the native dialer. Upon receiving the call to the temporary number, the cellular network replaces the user equipment identifier with the application identifier and places the call to the destination identified by the destination identifier. Because the user equipment identifier is replaced with the application identifier, the call received at the destination will appear to have originated from the application.

One example of receiving a call destined to user device in a cellular calling mode, for example, an application having selected the native dialer of the user equipment as the preferred dialer, includes informing the IMS Subsystem of the cellular network as to the preferred dialer to be used by the application. When the preferred dialer is the native dialer, a call made to the application is processed by the native dialer. For example, upon receiving the incoming call directed to the application, the IMS Subsystem of the cellular network identifies the call for redirection and identifies the contact number of the native dialer. The cellular network redirects the call from the application to the user equipment having the native dialer. The IMS Subsystem of the cellular network may perform this redirection following accessing the SIM information, including the telephone number of the user equipment and the telephone number(s) associated with the user account that the application is logged into, stored in a database. The database may be a database from the cellular network or a third-party database. Upon receiving the call, the native dialer of the user equipment forwards the call to the application for processing.

The disclosed systems and methods leverage the functionality of the application dialer using the native dialer to perform the telecommunications function. Functionality of the application dialer may be leveraged while using the native dialer to perform the call function. The native dialer is not limited by the quality of the data channel, thereby enhancing the call quality while accessing the functionality of the application driver. In an example, the application allows the user to select the functionality to be performed by the native dialer, and the functionality to be performed by the application dialer. In an example, the user may select one dialer for outgoing calls and a different dialer for incoming calls. In an example, the user may select the same dialer for both incoming and outgoing calls. The disclosed systems and methods provide the user with various choices to select an appropriate dialer in light of the dialer functionality and quality of the wireless connections. Example implementations are provided below with reference to the following figures.

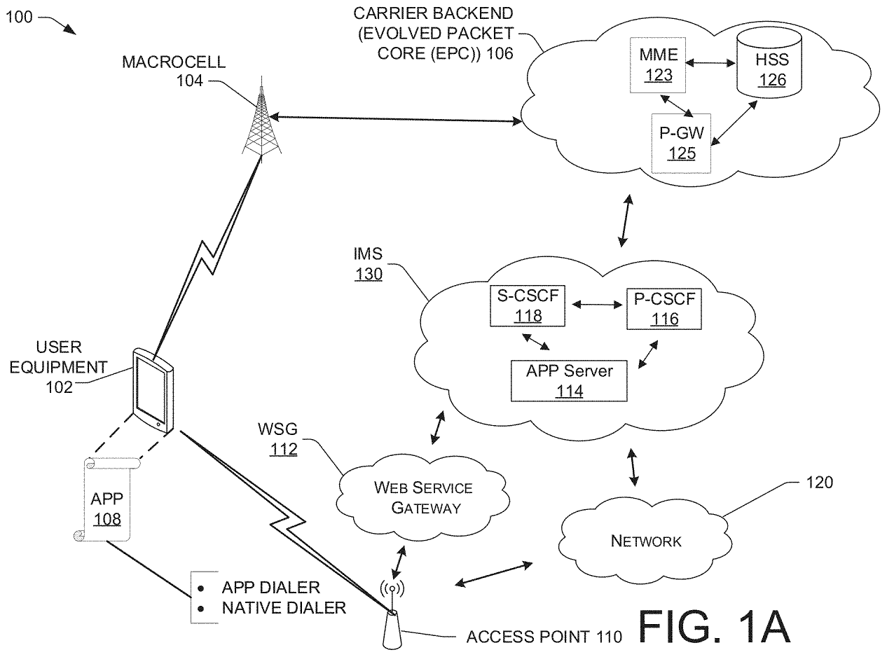

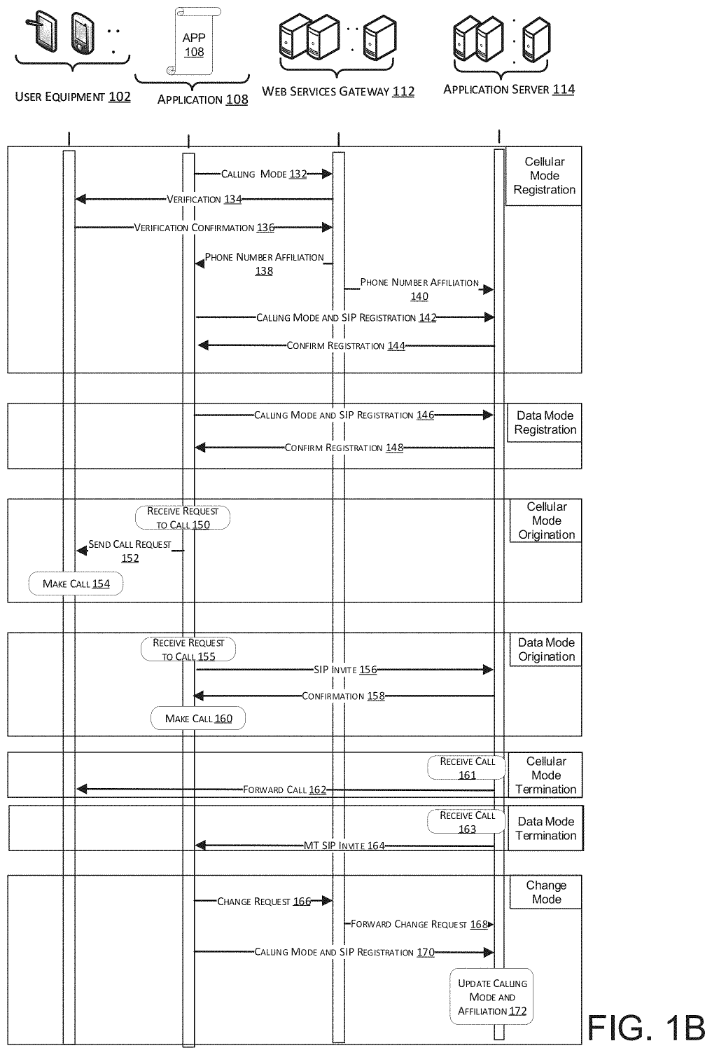

FIG. 1A is a schematic diagram of an example environment 100 for selecting the originating and/or terminating calling mode for an application installed on a user equipment. In this example, a user equipment and/or an application may select or change a calling mode by choosing between the dialer of the user equipment or an application dialer to perform the telecommunications function of the application. In another example, the user may select a calling mode to be used by any telecommunications application. The example environment 100 includes a user equipment 102, a macrocell 104, an application 108, an access point 110, an IP multimedia subsystem (IMS) 130, a web service gateway (WSG) 112, and an evolved packet core (EPC) 106 (i.e., a carrier backend). The EPC 106 in the depicted environment includes a Mobility Management Entity (MME) 123, a packet gateway (P-GW) 125, and a Home Subscriber Server (HSS) database 126. The EPC 106 is coupled to the IMS 130 and a network 120.

User equipment 102 may comprise any computing device and may be implemented as a single device or as a plurality of devices with components and data distributed among them. Example user equipment 102 includes a mobile phone, a wireless smartphone, a tablet computer, or any other computing device configured for cellular communications. The user equipment may include one or more additional wireless communications ports. In an example, the wireless communications port may be compliant with any unlicensed wireless protocol such as Wi-Fi (e.g., 802.11-based technologies), WiMax, Bluetooth, infrared communications, or any other wireless protocol. The user equipment may have a cellular voice channel for the native dialer and a cellular data channel. In an example, the wireless communications port may include another cellular communication channel that is separate from the cellular voice channel for the native dialer of the user equipment. The user equipment may also include one or more additional wireless data channels.

The user equipment 102 may communicate with the cellular network via EPC 106 and network 120 through macrocell 104. The communication channel between the user equipment 102 and the macrocell 104 may comprise at least a cellular voice channel and a cellular data channel. In an example, the user equipment may communicate with the cellular network via a small cell. In an example, the macrocell 104 may be replaced with a microcell, a picocell, or a femtocell. In an example, the user equipment 102 may communicate with the cellular network via a macrocell, small cell, microcell, a picocell, a femtocell, and/or combinations thereof

The macrocell 104 may include any node that provides radio access for user equipment 102. One example macrocell 104 is a node in an evolved UMTS Terrestrial Radio Access Network (E-UTRAN) of an LTE system. The E-UTRAN includes an evolved NodeB (eNodeB or eNB). In one example, an eNB functions similarly to a base transceiver station in a GSM network. The E-UTRAN facilitates communication between the UE 102 and the Evolved Packet Core (EPC) 106 of the LTE network. In an example, an eNB is connected to the EPC 106 of the mobile phone network and communicates directly with user equipment 102. In some examples, the macrocell 104 may include a gNodeB of a Fifth Generation (5G) cellular network.

In an example, the EPC 106 includes a Home Subscriber Server (HSS) database 126. The HSS database 126 includes a database for storing information about the subscribers of the mobile carrier. The HSS database 126 may be queried using an International Mobile Subscriber Identity (IMSI) and/or International Mobile Equipment Identity (IMEI) as keys. In one example, the IMSI number may be stored in the SIM card of the user equipment. The EPC 106 may also include a Mobility Management Entity (MME) 123 that interacts with the HSS database 126 to control operations of the user equipment. The HSS database 126 may store various customer information, the preferred dialer for the user equipment, or application dialer for the application, among other information.

The user equipment identity information may be obtained from various sources, including a SIM, UMTS Subscriber Identity Module (USIM), a CDMA Subscriber Identity Module (CSIM) or Re-Useable Identification Module (R-UIM), IP Multimedia Services Identity Module (ISIM), or from a database. The user equipment identity information may be stored in various databases, including the HSS database, databases in the EPC, and databases in the IMS Subsystem.

The EPC 106 may include an interface with external networks. In one example, the EPC includes a Packet Data Network (PDN) Gateway (P-GW) 125 for communicating with external networks using an SGI interface. The P-GW 125 may be connected to an external network such as the Internet. In other examples, the external network may include private or public networks.

The EPC 106 depicted in FIG. 1A is coupled to an IP Multimedia Subsystem (IMS) 130. IMS 130 is responsible for session management and media control. In one example, the IMS may control multimedia applications such as Voice over IP (VoIP), Voice over LTE (VoLTE), and Video over LTE (ViLTE). The IMS 130 may obtain the identity of a user equipment in numerous ways. For example, the user equipment may contain a Universal Integrated Circuit (UICC) that may include one or more of (1) a Subscriber Identity Module (SIM) containing SIM identity information used by a GSM network, (2) UMTS Subscriber Identity Module (USIM) containing USIM information used by a UMTS or LTE network, (3) CDMA Subscriber Identity Module (CSIM) or Re-Useable Identification Module (R-UIM) containing identify information for use by a CDMA network, or (4) IP Multimedia Services Identity Module (ISIM) containing identity information for use by an IMS subsystem. The IMS 130 may also obtain identification information associated with the application 108, such as telephone number(s) associated with a user account that the application 108 is logged into.

The information received by the IMS 130 may be receive via a Proxy Call Session Control Function (P-CSCF) 116, a Serving Call Session Control Function (S-CSCF) 118, or one or more application servers 114. The P-CSCF 116, S-CSCF 118, or application server(s) 114 may utilize the information received from the UE 102 and the application 108 in order to originate and/or terminate calls based on a determined calling mode (e.g., cellular mode or data mode).

The user equipment 102 may be coupled to a wireless access point such as an access point 110. In one example, the access point 110 may be a Wi-Fi access point compliant with 802.11-based technologies. In an example, the wireless access point may be compliant with WiMax, Bluetooth, infrared communications, or other wireless communication protocols. The wireless data channel is configured to wirelessly transmit data packets between the user equipment 102 and the access point 110.

The access point 110 may be connected to network 120. In one example, the network 120 is the Internet. The network 120 may be any public or private network. The network 120 may be connected to the carrier backend via the P-GW 125.

In an example, a user of the application 108 logs into a user account associated with telephone number(s) that may be accessed by the application 108. The application 108 queries the user to select between the native dialer of the user equipment and the application dialer of the application. In an example, the user equipment includes executable code that queries a user about a preferred dialer. When the user selects the native dialer (i.e., cellular mode), the voice and telecommunication services are provided by the native dialer rather than the application dialer. For example, the origination and termination of calls is normally performed by the application dialer. When the user selects the native dialer (i.e., cellular mode) of the user equipment to perform the call origination or termination, the application 108 notifies the application server 114 of the IMS 130 as to the preferred dialer for the user equipment. In some cases, the application 108 may send a transmission to the WSG 112 indicating the preferred calling mode and a verification of the UE 102 telephone number and/or the telephone number(s) associated with the application 108. By notifying the IMS 130, calls made by, or made to, the native dialer on behalf of the application 108 are identified and processed accordingly. A message may be sent to the IMS 130 to inform the IMS 130 that a native dialer will be used on behalf of the application 108.

The message may include an identifier of UE 102 and an identifier of the application 108. One example of an identifier of the UE 102 is a telephone number of the UE 102. The identifier of the UE 102 may be obtained from the SIM card of the UE 102. In another example, telephone number and/or other SIM information of the UE 102 may be obtained from a Universal Subscriber Identity Module (USIM) of the UE 102 rather than from a SIM. In an example, the identity of the preferred dialer may be obtained by querying a cellular database for the Subscriber Information Module (SIM) number of the user equipment. In an example, the SIM information, including the telephone number of the UE 102, may be transmitted from the UE 102, via the application 108, to the cellular network for storage in the HSS 126 or the application server 114. The identifier of the application 108 may be a number or label associated with the application 108 that allows identification of the application 108. The message may also include the telephone number(s) associated with the user account that the application 108 is logged into and an instruction to create an affiliation between the telephone number of the UE 102 and the telephone number(s) associated with the user account that the application 108 is logged into.

After receiving a message that the native dialer of the UE 102 will be used for the application 108, calls made to, or by the application 108 may be redirected as calls made to, or by the native dialer of the UE 102. In an example, the IMS 130 of the cellular network performs the redirection.

The SIM information may be obtained from a universal integrated circuit card (UICC). In an example, the UICC includes a universal subscriber identity module (USIM). The UICC may also include an ISIM, SIM, USIM, CSIM, or R-UIM. The USIM may include a SIM number and an International Mobile Equipment Identity (IMEI). The SIM number provides contact information (such as the telephone number) of the user equipment. In an example, the SIM number may be used as a key into a database (such as a HSS database 126) to obtain the contact or telephone number of the user equipment. In an example, the SIM information may be stored in an IP Multimedia Services Identity Module (ISIM). The IMEI identifies or indicates the identity of the user equipment 102. The IMEI may be stored (i) the user equipment, (ii) in a database operated by the mobile carrier associated with the user of the UE, (iii) in database accessible by the mobile carrier, or (iv) in a third-party database. The IMEI may be stored in the one or multiple databases.

FIG. 1B depicts call flow between a user equipment (UE) 102, an application 108, a WSG 112, and an application server 114 for registering the application 108 and/or the UE 102 to operate in a cellular mode or a data mode and to originate calls, terminate calls, or change mode while operating in the cellular mode or the data mode. The UEs 102 may be any type of electronic device capable of various types of communications (e.g., audio, video, text messaging, etc.) including, but not limited to, cell phones, smart phones, tablet computers, and laptop computers. For ease of explanation, the transmissions are shown going straight from the UE 102 to the WSG 112 or the application server 114. One of skill in the art will recognize that, in reality, connections can involve several additional network entities such as, for example, a home subscriber service (HSS) and/or a proxy call session control function (P-CSCF) server, which are not shown in FIG. 1B.

At 132, while registering to operate in a cellular mode, the application 108 may send a transmission indicating a preferred calling mode (e.g., cellular mode) to the WSG 112. The transmission may include a phone number or multiple phone numbers that are associated with the application 108 and/or a user account associated with the application 108 as well as a phone number associated with the UE 102. In some cases, the transmission may instruct the WSG 112 to create an affiliation between the phone number(s) associated with the application 108 and the phone number associated with the UE 102. For example, the UE 102 may be associated with a first network operator that is different than a second network operator that is associated with the application 108. A user may desire to access (e.g., originate calls, terminate calls, etc.) phone numbers that are associated with the second network operator via the application 108 while the application 108 is running on the UE 102.

At 134, the WSG 112 may send a transmission to the UE 102 for verification that the phone number of the UE 102 should be affiliated with the phone number(s) of the application 108. At 136, the UE 102 may send a transmission to the WSG 112 confirming that the phone number of the UE 102 should be affiliated with the phone number(s) of the application 108.

At 138, the WSG 112 may send a transmission to the application 138 verifying that the phone number of the UE 102 has been affiliated with the phone number(s) of the application 108.

At 140, the WSG 112 may send a transmission to the application server 114 indicating that the phone number of the UE 102 should be affiliated with the phone number(s) of the application 108.

At 142, the application 108 may send a transmission to the application server 114 including a SIP REGISTER and an indication that the application 108 is operating in the cellular mode. In some cases, an SIP REGISTER may include a custom field and a regular field, and the custom field may include data informing the application server 114 that the telephone number(s) associated with the application 108 are activated and are affiliated with the telephone number associated with the UE 102.

At 144, the application server 114 may send a transmission to the application 108 including a confirmation that the SIP has been registered and that the application server 114 is aware that the application 108 is operating in the cellular mode.

At 146, while registering to operate in the data mode, the application 108 may send a transmission to the application server 114 including a SIP REGISTER and an indication that the application 108 is operating in the data mode.

At 148, the application server 114 may send a transmission to the application 108 including a confirmation that the SIP has been registered and that the application server 114 is aware that the application 108 is operating in the data mode.

At 150, the application 108 may receive a request to make an outgoing call while operating in a cellular mode and at 152 the application 108 may send a transmission to the UE 102 to make the outgoing call. At 154, the UE 102 may make the outgoing call on behalf of the application 108. For example, the outgoing call may be placed on a native dialer of the UE 102. In some cases, when the application 108 requests to make a call in a cellular mode, the application 108 may send a request for a temporary routing number (e.g., IMS routing number) from the application server 114 that may be used as a pairing number between the telephone number of the application 108 and the called number. When the request is sent, the WSG 112 may receive, from the application 108, the telephone number of the application 108, the telephone number of the UE 102, and the called number, which may then be forwarded to the application server 114, which may then assign the temporary routing number. The application server 114 may send the temporary routing number back to the application 108, then the application 108 may send the temporary routing number to the native dialer of the UE 102. The native dialer of the UE 102 may call the temporary routing number, which is forwarded to the application server 114, which knows that the temporary routing number is associated with the telephone number of the application 108 and the called number. The application server 114 may then place the call and remove the telephone number of the UE 102 and replaces it with the telephone number of the application 108.

At 155, the application 108 may a receive a request to make an outgoing call while operating in a data mode and at 156 the application 108 may send a transmission to the application server 114 (e.g., a SIP Invite) to make the outgoing call. At 158, the application server 114 may send a transmission to the application 108 confirming that the application 108 is allowed to make the outgoing call and at 160 the application 108 may make the outgoing call while operating in a data mode. For example, the outgoing call may be placed on an application dialer of the application 108 via a Wi-Fi network.

At 161, the application server 114 may receive a call request while the application 108 is operating in a cellular mode and at 162 the application server 114 may forward the incoming call (e.g., by sending a mobile terminating (MT) SIP Invite) to the UE 102. For example, while operating in the cellular mode, the application server 114 may store an affiliation between the phone number of the UE 102 and the phone number(s) of the application 108. When the application server 114 receives a call request for the phone number(s) of the application 108, the application server 114 may send an MT SIP INVITE to the UE 102 in response to the application 108 operating in the cellular mode. In some cases, before the MT SIP INVITE is sent to the UE 102, a transmission (e.g., SIP message) may be sent to the application 108 from the from application server 114 and the application 108 may generate a temporary contact including an association of the incoming call with the application 108, so that when the incoming call is received by the UE 102, the UE 102 will generate a notification indicating the incoming caller telephone number and whether or not the number is calling the application 108 or the UE 102.

At 163, the application server 114 may receive a call request while the application 108 is operating in a data mode and at 164 the application server 114 may send a MT SIP Invite to the application 108. For example, the application 108 may have previously sent an SIP REGISTER to the application server 114 and an indication that the application 108 is operating in the data mode. When the application server 114 receives a call request for the phone number(s) of the application 108, the application server 114 may send an MT SIP INVITE to the application 108 in response to the application 108 operating in the data mode.

At 166, the application 108 may send a request to the WSG 112 to change the operating mode of the application 108. In cases where the calling mode is changing from a cellular mode to a data mode, the request may include instructions to delete the affiliation between the phone number of the UE 102 and the phone number(s) of the application 108. In cases where the calling mode is changing from a data mode to a cellular mode, the request may include instructions to generate an affiliation between the phone number of the UE 102 and the phone number(s) of the application 108. In some cases, the request to change the operating mode may be performed automatically by the application 108 based on a quality-of-service (QoS) metric measured by the application 108, a location of the UE 102, and/or an overall quality of coverage in an area proximate to the UE 102.

At 168, the WSG 112 may forward the request to the application server 114 and at 170 the application 108 may send an updated calling mode and SIP REGISTER to the application server 108. For example, in cases where the calling mode is changing form the cellular mode to the data mode, the application 108 may send a transmission to the application server 114 including a SIP REGISTER and an indication that the application 108 is operating in the data mode. In cases where the calling mode is changing form the data mode to the cellular mode, the application 108 may send a transmission to the application server 114 including a SIP REGISTER and an indication that the application 108 is operating in the cellular mode.

At 172, the application server may update the stored calling mode and any phone number affiliation information associated with the UE 102 and the application 108.

At 178, the recipient UE 172 can select between a cellular calling mode and a data calling mode. The recipient UE 172 in a cellular calling mode may use the native dialer to originate or terminate calls. The recipient UE 172 in a data calling mode may use an application dialer to make or terminate calls.

It should be understood that all of the transmissions associated with the flow illustrated in FIG. 1B may be implemented using any number of protocols, such as, but not limited to any protocol found in RFC 3261. In some cases, the communication protocols may include a REST API, a SMS message, a SIP RESPONSE, SIP 200 OK, a SIP INVITE, a HTTP POST, MT SIP INVITE, and the like.

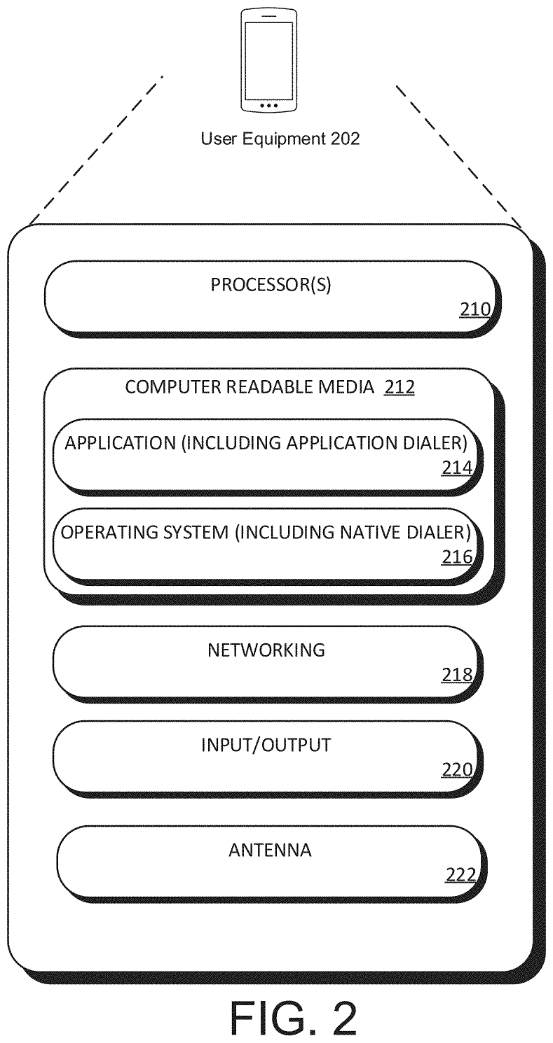

FIG. 2 depicts an example user equipment 202 that allows selection of calling modes for selecting between a native dialer of the user equipment and an application dialer of an application. In this example, user equipment 202 includes one or more processors 210, a computer readable media 212 storing an application 214 (including an application dialer) and an operating system 216 (including a native dialer), networking component 218 for communicating with non-cellular data networks such as the Internet, input/output ports 220 for user interaction, and an antenna 222 for communicating with the cellular network.

The one or more processors 210 may be any type of computer processor that can execute computer instructions. In one example, the processors may be distributed across multiple hardware elements. In an example, the some or all the processing power may be located remotely such as in a server computer or processors in a remote cloud environment.

The computer readable media 212 may be any type of volatile or nonvolatile storage. For example, the computer readable media may be magnetic disks, optical disks, or tape. The computer readable media may also include memory devices such as RAM, ROM, firmware, flash memory, EEPROM, or other types of memory storage known to one of ordinary skill in the art. Tangible computer-readable media can include volatile and nonvolatile, removable and non-removable media implemented in any method or technology for storage of information, such as computer readable instructions, data structures, program modules, or other data. Memory is an example of a computer-readable storage media. Computer-readable storage media include, but are not limited to, RAM, ROM, EEPROM, flash memory or other memory technology, CD-ROM, digital versatile discs (DVD), content-addressable memory (CAM), or other optical storage, magnetic cassettes, magnetic tape, magnetic disk storage or other magnetic storage devices, or any other medium which can be used to store the desired information and which can be accessed by the user equipment 202. Any such tangible computer-readable media may be part of user equipment 202.

The computer readable media 212 may include instructions encoding the application 214 and operating system 216. The application 214 includes an application dialer. In an example, the application includes instructions allowing a user to select to use the native dialer with the application 214. In an example, the computer instructions for selecting between a native dialer and an application dialer may be provided by a separate application or the operating system 216 of the user equipment. In an example the computer instructions may include instructions for selecting between a cellular calling mode and a data calling mode. A user equipment in a cellular calling mode may use the native dialer to originate or terminate calls. A user equipment in a data calling mode may use an application dialer to make or terminate calls. The computer readable media 212 may include an operating system 216 for the user equipment 202. The operating system 216 may include the native dialer of the user equipment 202. In an example, the native dialer of the user equipment 202 may be provided by an application or another software module.

User equipment 202 may include a networking component 218 for providing ports and modules for communicating with the outside world. The networking component 218 may include transceiver ports for local area networks (LANs) and wide area networks (WANs). In one example, the LAN and/or WAN ports provide a wired connection to the Internet. The networking component 218 may also include a wireless communications module that includes one or more wireless transceivers. For example, the transceivers can include a network interface card (NIC), a network adapter, a LAN adapter, or a physical, virtual, or logical address to connect to various network(s), or to the user equipment 202, for example. To increase throughput for exchanging wireless data, the transceivers may utilize multiple-input/multiple-output (MIMO) technology or other high throughput wireless standards such as 802.11ac. The transceivers may comprise any type of wireless transceivers capable of engaging in wireless, radio frequency (RF) communication. The transceivers can also include other wireless modems, such as a modem for engaging in Wi-Fi, WiMax, Bluetooth, or infrared communication.

User equipment 202 may include input/out (I/O) ports 220 for input/output devices. The I/O ports may include USB, serial, parallel, HDMI, display ports, digital video interface (DVI), Ethernet, and any other ports known to a person of ordinary skill in the art. These input/out ports may collectively be referred to as I/O ports 220. The I/O ports interface with device(s), such as a keypad, a cursor control, a touch-sensitive display, voice input device, etc., a display, speakers, printers, etc. In an example, the input/output ports allow a user to select a dialer for use with application 214. These ports are well known in the art and need not be discussed at length here.

Antenna 222 provides the user equipment with radio frequency (RF) communications with a cellular network. In one example, antenna 222 provides wireless connection between a macrocell and user equipment 202.

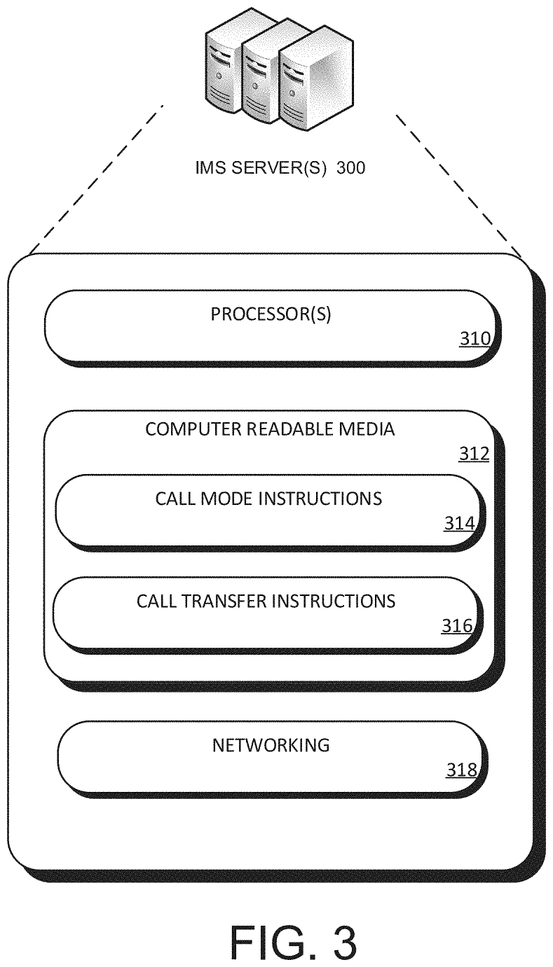

FIG. 3 is an example server within an IP Multimedia Subsystem (IMS) that routes the calls between the origination and termination points. In an example, the server depicted in FIG. 3 may be part of the EPC 106. In an example, the server depicted in FIG.3 may be included in a macrocell. In an example, the IMS server may be located in the IMS 130. In an example, the IMS server may comprise the application server 114. The IMS server includes one or more processors 310, computer readable media 312 storing call mode instructions and call transfer instructions, and networking component 318.

The one or more processors 310 may be any type of computer processor that can execute computer instructions. In one example, the processors may be distributed across multiple hardware elements. In an example, the some or all the processing power may be located remotely such as in a server computer or processors in a remote cloud environment.

The computer readable media 312 may be any type of volatile or nonvolatile storage. For example, the computer readable media may be magnetic disks, optical disks, or tape. The computer readable media may also include memory devices such as RAM, ROM, firmware, flash memory, EEPROM, or other types of memory storage known to one of ordinary skill in the art. Tangible computer-readable media can include volatile and nonvolatile, removable and non-removable media implemented in any method or technology for storage of information, such as computer readable instructions, data structures, program modules, or other data. Memory is an example of a computer-readable storage media. Computer-readable storage media include, but are not limited to, RAM, ROM, EEPROM, flash memory or other memory technology, CD-ROM, digital versatile discs (DVD), content-addressable memory (CAM), or other optical storage, magnetic cassettes, magnetic tape, magnetic disk storage or other magnetic storage devices, or any other medium which can be used to store the desired information and which can be accessed by the IMS server 300. Any such tangible computer-readable media may be part of IMS server 300.

The computer readable media 312 may include instructions encoding the call mode instructions 314 and call transfer instructions 316. The call mode instructions provide the functionality for determining whether a user equipment or an application is using the native dialer of the user equipment or the application dialer of the application. The call transfer instructions provide the functionality for transferring a received call to the destination of the call. The call transfer instructions ensure that the call made by the application (whether through via the application dialer or the native dialer) arrive at the destination and appear to have been originated from the application. Furthermore, the call transfer instructions receive calls made to an application installed on a user equipment and transfer the call to the native dialer or the application dialer, depending on the user selections.

In an example, the call mode instructions include instructions for receiving a selection of a call mode from a user equipment. For example, the IMS server 300 may include instructions that upon receipt of a cellular calling mode, cause the IMS server 300 to receive calls from, or direct calls to, the native dialer of the user equipment. The IMS server 300 may also include instructions that upon receipt of a data calling mode, cause the IMS server 300 to receive calls from, or direct calls to, an application dialer of the user equipment.

IMS server 300 may include networking component 318 modules for providing ports and modules for communicating with the outside world. The networking component 318 may include transceiver ports for local area networks (LANs) and wide area networks (WANs). In one example, the LAN and/or WAN ports provide a wired connection to the Internet. The LAN and/or WAN ports also provide a wired connection to the macrocell. The networking component 318 may also include a wireless communications module that includes one or more wireless transceivers. For example, the transceivers can include a network interface card (NIC), a network adapter, a LAN adapter, or a physical, virtual, or logical address to connect to various network(s), or to the IMS server 300, for example. To increase throughput for communicating wireless data, the transceivers may utilize multiple-input/multiple-output (MIMO) technology or other high throughput wireless standards such as 802.11ac. The transceivers may comprise any type of wireless transceivers capable of engaging in wireless, radio frequency (RF) communication. The transceivers can also include other wireless modems, such as a modem for engaging in Wi-Fi, WiMax, Bluetooth, or infrared communication.

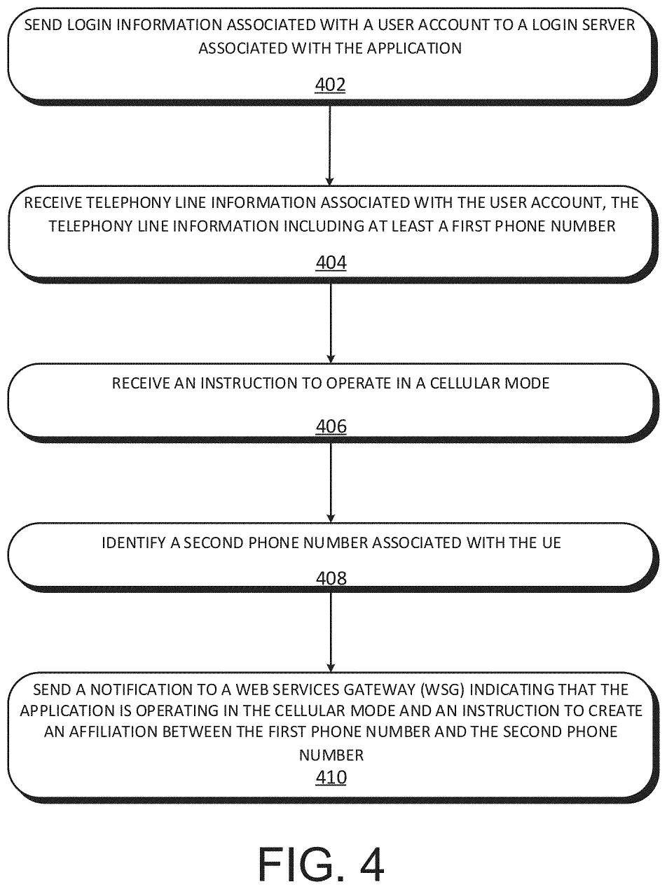

FIG. 4 illustrates an example method for selecting a preferred dialer for an application. In this example, an application having telecommunication functions has been installed on a user equipment. In one example, the user equipment may send login information associated with a user account to a login server associated with the application at block 402. For example, the UE 102 may store the application 108 and may be in communication with a login server that may be operated by the same network operator that operates the EPC 106, which may store user account information such as one or more telephone numbers associated with the user account that can be accessed via the application 108. The application 108 may include an over-the-top (OTT) applications that may be installed on user equipment to provide telecommunication functions such as making or receiving a call, merging calls, putting a call on hold, conference calling, and video conferencing, among other functions. These OTT applications may provide a dialer for originating or terminating phone calls and may have access to a user account that is associated with a single telephone number or multiple telephone numbers that are associated with the user account.

At block 404, the UE may receive telephony line information associated with the user account, the telephony line information including at least a first phone number.

At block 406, the UE may receive an instruction to operate in a cellular mode. In one example, a user selects a calling mode for use with the OTT application. The user may select to use the native dialer installed with the operating system or the application dialer installed with the application for making or receiving calls using the application. When the user selects the native dialer of the operating system to perform the telecommunication functions such as a video call, the video call is made using a dedicated bearer for the voice component and a dedicated bearer for the video component of the call.

At block 408, the UE may identify a second phone number associated with the UE. In one example, When the user selects the native dialer (i.e., cellular mode) to perform telecommunication functions of the application, the user equipment and/or the application may inform the cellular network that the native dialer is the preferred dialer for originating and/or terminating calls for the user equipment. The user equipment may notify the cellular network in various ways. In an example, the user equipment notifies the IMS Subsystem as to the preferred dialer for the user equipment. By notifying the IMS Subsystem, calls made by, or made to, the native dialer on behalf of the application are identified and processed accordingly. A message may be sent to the IMS Subsystem to inform the IMS subsystem that a native dialer will be used on behalf of an application. The user equipment may also inform the cellular network of the preferred dialer based on a selection of cellular calling model or data calling mode.

The message may include an identifier of native dialer and an identifier of the application. One example of an identifier of the native dialer is a telephone number of the user equipment. The identifier of the native dialer of the user equipment may be obtained from the SIM card of the user equipment. In another example, telephone number and/or other SIM information of the user equipment may be obtained from a Universal Subscriber Identity Module (USIM) of a user equipment rather than from a SIM. In an example, the identity of the preferred dialer may be obtained by querying a cellular database for the Subscriber Information Module (SIM) number of the user equipment. An example cellular database is a Home Subscriber Server database. In an example, the SIM information, including the telephone number of the user equipment, may be transmitted from the user equipment to the cellular network for storage in the carrier backend system. The SIM information may be stored in a database accessible by the carrier backend. The identifier of an application may be a number or label associated with the application that allows identification of the application. The message may also include the telephone number(s) associated with the user account that the application is logged into and an instruction to create an affiliation between the telephone number of the native dialer and the telephone number(s) associated with the user account that the application is logged into.

At block 410, the UE may send a notification to a web services gateway (WSG) indicating that the application is operating in the cellular mode and an instruction to create an affiliation between the first phone number and the second phone number. In one example, while registering to operate in a cellular mode, the application 108 may send a transmission indicating a preferred calling mode (e.g., cellular mode) to the WSG 112. The transmission may include a phone number or multiple phone numbers that are associated with the application 108 and/or a user account associated with the application 108 as well as a phone number associated with the UE 102. In some cases, the transmission may instruct the WSG 112 to create an affiliation between the phone number(s) associated with the application 108 and the phone number associated with the UE 102. For example, the UE 102 may be associated with a first network operator that is different than a second network operator that is associated with the application 108. A user may desire to access (e.g., originate calls, terminate calls, etc.) phone numbers that are associated with the second network operator via the application 108 while the application 108 is running on the UE 102.

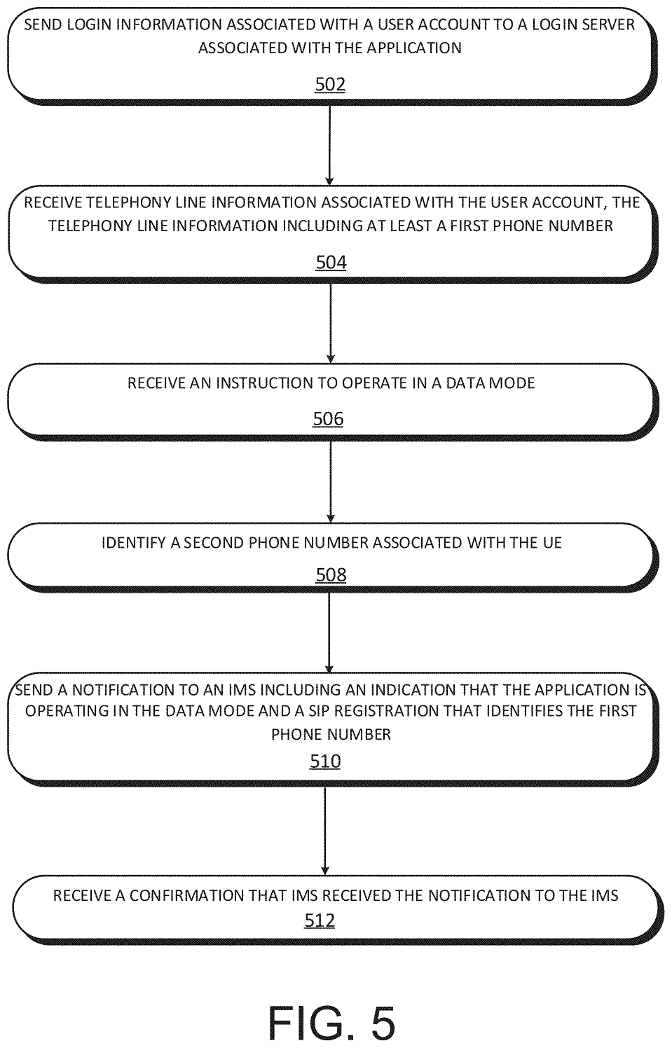

FIG. 5 illustrates an example method for selecting a preferred dialer for an application. In this example, an application having telecommunication functions has been installed on a user equipment. In one example, the user equipment may send login information associated with a user account to a login server associated with the application at block 502. For example, the UE 102 may store the application 108 and may be in communication with a login server that may be operated by the same network operator that operates the EPC 106, which may store user account information such as one or more telephone numbers associated with the user account that can be accessed via the application 108. The application 108 may include an over-the-top (OTT) applications that may be installed on user equipment to provide telecommunication functions such as making or receiving a call, merging calls, putting a call on hold, conference calling, and video conferencing, among other functions. These OTT applications may provide a dialer for originating or terminating phone calls and may have access to a user account that is associated with a single telephone number or multiple telephone numbers that are associated with the user account.

At block 504, the UE may receive telephony line information associated with the user account, the telephony line information including at least a first phone number.

At block 506, the UE may receive an instruction to operate in a data mode. In an example, OTT applications may use the Internet connection of the user equipment to offer telecommunication services to make and receive calls. The cellular network of the cellular provider may provide the user equipment with a data connection to the Internet. In an example, an access point such as a Wi-Fi access point may provide the user equipment with a direct connection to a network such as the Internet and/or a web service gateway. In one example, an OTT voice application may use the user equipment's data connection to the Internet over an LTE network to offer a voice service that is independent of the cellular service provider. In an example, the OTT application does not access a cellular voice channel dedicated to the native dialer. In some examples, a user may utilize the OTT application to login to a user account thereby providing the user access to telephone number(s) that are associated with the user account. When the user selects the application dialer to perform the telecommunications functions, the calls may be made using user equipment's data connection to the Internet (either over the LTE network, or a direct connection to the Internet) to provide voice services that are independent of the cellular network provider.

At block 508, the UE may identify a second phone number associated with the UE. In one example, the application may determine an identifier of a native dialer and an identifier of the application. One example of an identifier of the native dialer is a telephone number of the user equipment. The identifier of the native dialer of the user equipment may be obtained from the SIM card of the user equipment. In another example, telephone number and/or other SIM information of the user equipment may be obtained from a Universal Subscriber Identity Module (USIM) of a user equipment rather than from a SIM. In an example, the identity of the preferred dialer may be obtained by querying a cellular database for the Subscriber Information Module (SIM) number of the user equipment. An example cellular database is a Home Subscriber Server database. In an example, the SIM information, including the telephone number of the user equipment, may be transmitted from the user equipment to the cellular network for storage in the carrier backend system. The SIM information may be stored in a database accessible by the carrier backend.

At block 510, the UE may send a notification to an IMS including an indication that the application is operating in the data mode and a SIP registration that identifies the first phone number. In one example, the application 108 may send a transmission to the application server 114 including a SIP REGISTER and an indication that the application 108 is operating in the data mode. In some examples, the application 108 may a receive a request to make an outgoing call while operating in a data mode and the application 108 may send a transmission to the application server 114 (e.g., a SIP Invite) to make the outgoing call. The application server 114 may send a transmission to the application 108 confirming that the application 108 is allowed to make the outgoing call and the application 108 may make the outgoing call while operating in a data mode. For example, the outgoing call may be placed on an application dialer of the application 108 via a Wi-Fi network.

At block 512, the UE may receive a confirmation that the IMS received the notification to the IMS. In one example, the application server 114 may send a transmission to the application 108 including a confirmation that the SIP has been registered and that the application server 114 is aware that the application 108 is operating in the cellular mode.

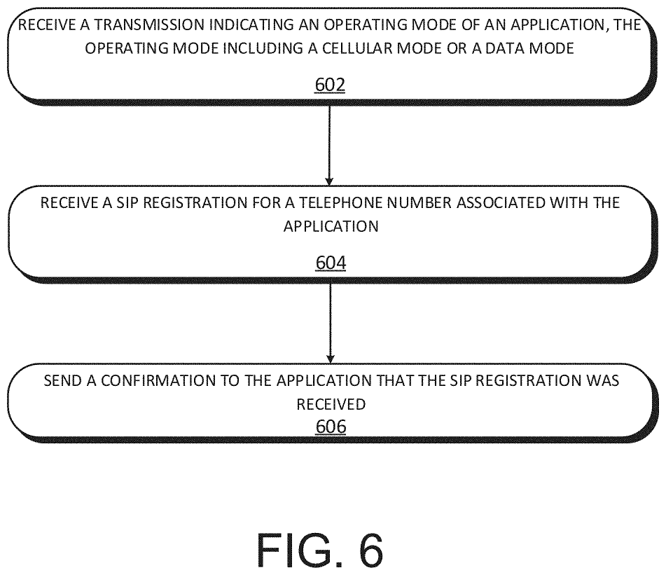

FIG. 6 illustrates an example method, performed by an application server, for registering a calling mode of an application. In this example, the application server may be part of an IMS. At block 602, the application server may receive a transmission indicating an operating mode of an application, the operating mode including a cellular mode or a data mode. In one example, an indication of the selected dialer (native dialer or application dialer) may be provided to the IMS subsystem. The indication of the preferred dialer or identification of the preferred dialer may be sent in a message to the cellular network. For example, a message may be sent to the backend carrier system via the Internet (through an unlicensed wireless communication) or via the cellular network via the macrocell. In an example, a message may be sent to the IMS Subsystem via the cellular network or the wireless network. In an example, the IMS Subsystem may receive as message from the user equipment to identify the preferred calling mode to be used by the user equipment. Regardless of the method of communication, the cellular network receives a message that an application will use a preferred dialer for originating or terminating calls. In one example, the WSG 112 may send a transmission to the application server 114 indicating that the phone number of the UE 102 should be affiliated with the phone number(s) of the application 108.

At block 604, the application server may receive a SIP registration for a telephone number associated with the application. For example, the application 108 may send a transmission to the application server 114 including a SIP REGISTER and an indication that the application 108 is operating in the cellular mode. In some cases, an SIP REGISTER may include a custom field and a regular field, and the custom field may include data informing the application server 114 that the telephone number(s) associated with the application 108 are activated and are affiliated with the telephone number associated with the UE 102.

At block 606, the application server may send a confirmation to the application that the SIP registration was received. In an example, the application server 114 may send a transmission to the application 108 including a confirmation that the SIP has been registered and that the application server 114 is aware that the application 108 is operating in the cellular mode.

Although embodiments have been described in language specific to structural features and/or methodological acts, it is to be understood that the disclosure is not necessarily limited to the specific features or acts described. Rather, the specific features and acts are disclosed as illustrative forms of implementing the claims.

What is claimed is:

1. A user equipment (UE) comprising:
one or more processors; and
a memory storing instructions, that when executed, cause the one or more processors to:
cause an application stored in the memory to:
send login information associated with a user account to a login server associated with the application;
receive telephony line information associated with the user account, the telephony line information including at least a first phone number;
receive an instruction to operate in a cellular mode;
identify a second phone number associated with the UE; and
send a notification to a web services gateway (WSG) indicating that the application is operating in the cellular mode and an instruction to create an affiliation between the first phone number and the second phone number.

2. The user equipment of claim 1, further comprising causing the application to:
send a notification to an IP Multimedia Subsystem (IMS) including a SIP registration and an indication that the application is operating in the cellular mode; and
receive a confirmation that the IMS received the notification to the IMS.

3. The user equipment of claim 1, wherein the notification to the WSG includes a UE identifier identifying the UE and an application number identifying the application.

4. The user equipment of claim 3, wherein the UE identifier is based at least on part on a Subscriber Identity Module (SIM), a Universal Mobile Telecommunications System Subscriber Identity Module (USIM), a CDMA Subscriber Identity Module (CSIM), Re-Useable Identification Module (R-UIM), or an IP Multimedia Services Identity Module (ISIM)).

5. The user equipment of claim 1, further comprising causing the application to:
receive a request to place an outgoing call; and
in response to determining that the application is operating in the cellular mode, cause the UE to place the outgoing call using a native dialer of the UE.

6. The user equipment of claim 5, wherein placing the outgoing call includes accessing a cellular network including at least one of a Global System for Mobile communications (GSM), code-division multiple access (CDMA), Universal Mobile Telecommunications Service (UMTS), Long-Term Evolution (LTE), or a 5^{th} Generation (5G) network.

7. The user equipment of claim 1, further comprising receiving a mobile terminating (MT) SIP invite addressed to the UE from an IMS in response to operating in the cellular mode.

9. A user equipment (UE) comprising:
one or more processors; and
a memory storing instructions, that when executed, cause the one or more processors to:
cause an application stored in the memory to:
send login information associated with a user account to a login server associated with the application;
receive telephony line information associated with the user account, the telephony line information including at least a first phone number;
receive an instruction to operate in a data mode;
identify a second phone number associated with the UE; and
send a notification to an IMS including an indication that the application is operating in the data mode and a SIP registration that identifies the first phone number; and
receive a confirmation that the IMS received the notification to the IMS.

10. The user equipment of claim 9, further comprising causing the application to:
receive a request to place an outgoing call;
in response to determining that the application is operating in the data mode, send a SIP invite to the IMS;
receive a confirmation that the IMS received the SIP invite; and
place the outgoing call.

11. The user equipment of claim 9, further comprising causing the application to:
receive a MT SIP invite addressed to the application from an IMS in response to operating in the data mode.

12. The user equipment of claim 9, further comprising automatically switching from the data mode to a cellular mode based at least in part on:
a location of the UE; or
a quality of service (QOS) determination.

13. An application server comprising:
one or more processors; and
a memory storing instructions, that when executed, cause the one or more processors to:
receive a transmission indicating an operating mode of an application, the operating mode including a cellular mode or a data mode;
receive a SIP registration for a telephone number associated with the application; and
send a confirmation to the application that the SIP registration was received.

14. The application server of claim 13, wherein the CAS server is stored in an IP Multimedia Subsystem (IMS).

15. The CAS server of claim 13, further comprising, in response to the operating mode comprising the cellular mode, receiving a request to generate an affiliation for the telephone number associated with the application and a telephone number associated with a UE that is storing the application and that incoming calls to the telephone number associated with the application be sent to the telephone number associated with the UE.

16. The application server of claim 15, further comprising, in response to the operating mode comprising the cellular mode:
receiving a request to terminate a call associated with the telephone number associated with the application;
determining that the telephone number associated with the application is affiliated with the telephone number associated with the UE; and
sending a Mobile Termination (MT) SIP INVITE to the UE.

17. The application server of claim 13, further comprising, in response to the operating mode comprising the data mode:
receiving a SIP Invite from the application to initiate an outgoing call using the telephone number associated application; and
place the call using the telephone number associated with the application.

18. The application server of claim 13, further comprising:
receiving a request to terminate a call associated with the telephone number associated with the application;
determining that the application is operating in data mode; and
sending a Mobile Termination (MT) SIP INVITE to the application.

19. The application server of claim 15, further comprising, in response to the operating mode comprising the cellular mode:
receiving a transmission from a web serves gateway (WSG) instructing the CAS to delete the affiliation; and
receiving a new SIP registration indicating that the application is operating in the data mode.

20. The application server of claim 13, further comprising, in response to the operating mode comprising the data mode:
receiving a request to generate an affiliation for the telephone number associated with the application and a telephone number associated with a UE that is storing the application and that at least one of incoming calls or outgoing calls of the telephone number associated with the application be sent to the telephone number associated with the UE; and
receiving a new SIP registration indicating that the application is operating in the cellular mode.
